(19) United States
(12) Patent Application Publication
(10) Pub. No.: US 2009/0174255 A1
(43) Pub. Date: Jul. 9, 2009

(54) ACTUATOR ASSEMBLY FOR CONTROLLING A FUEL INJECTION SYSTEM OF A LARGE COMBUSTION ENGINE

(75) Inventors: Tommy Dahlberg, Vaasa (FI); Jonas &Aring;kerman, Sundom (FI); Johan Pensar, Vaasa (FI); Silvio Casini, Trieste (IT)

Correspondence Address: SMITH-HILL AND BEDELL, P.C., 16100 NW CORNELL ROAD, SUITE 220, BEAVERTON, OR, 97006, US

(73) Assignee: Wärtsilä Finland OY, Vaasa (FI)

(21) Appl. No.: 12/373,196

(22) PCT Filed: Jun. 4, 2007
(86) PCT No.: PCT/FI2007/050323

§ 371 Date: Feb. 17, 2009

(30) Foreign Application Priority Data
Jul. 10, 2006 (FI) 20065491

(51) Int. Cl. B60L 1/00; H02J 7/34

(52) U.S. Cl. 307/10.1; 307/48

(57) ABSTRACT

The invention relates to an actuator assembly for controlling fuel injection of a large combustion engine, especially a diesel engine, including an electric motor (6) acting on a control shaft (8) arranged to control the fuel injection and actuator control means (2,3) provided with an electric power supply (4,5) for controlling the electric motor (6). According to the invention the actuator assembly is provided with backup power in the form of capacitor power (12) arranged to provide power for the actuator control means (2,3) in case of loss of power or power failure of the electric power supply (4,5) so as to enable the actuator control means (2,3) to control the electric motor (6) to drive the control shaft (8) to a predefined safe position.

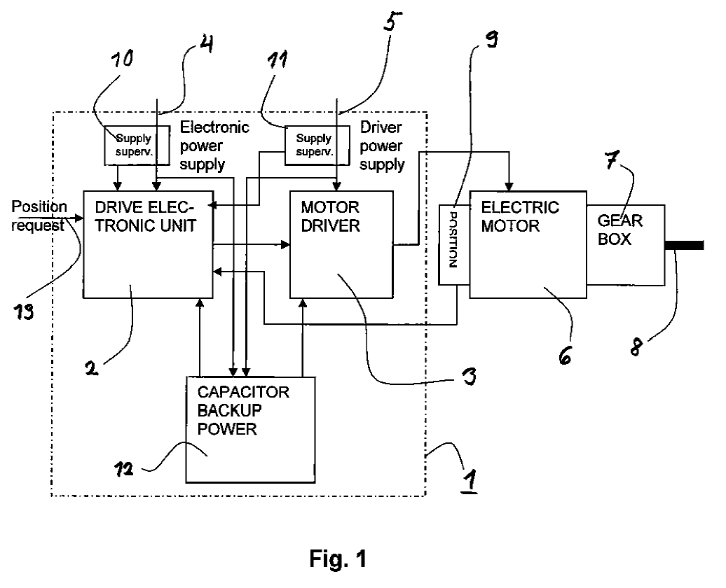

### TECHNICAL FIELD

The invention relates to an actuator assembly for controlling fuel injection of a large combustion engine according to preamble of claim 1.

### BACKGROUND ART

The fuel injection system of large diesel engines, commonly used for marine propulsion or production of electricity, works based on the principle that the delivery of the cylinder-wise fuel pumps is adjusted through a common rotating fuel adjustment shaft. By rotating the shaft, acting on a fuel rack engaged with the fuel pumps, the delivery of the fuel pumps can be adjusted from no delivery to full delivery.

The rotation of the fuel control shaft is traditionally handled by a hydraulic/mechanical governor or actuator. Recently, the hydraulic actuator has become more popular due to the fact that by electronic speed control, the emissions and smoke can be reduced, particularly during start of the engine. By electronic speed control of the engine in combination with an actuator, also more sophisticated electricity generation schemes and load-sharing are possible.

The hydraulic/mechanical actuators have, however, some disadvantages, such as high costs, low reliability and limited performance. Due to this, another type of actuators is starting to become more popular. This type of actuators is based on electric motors that through e.g. some type of servo circuit actuate the fuel control shaft. With this method, it is possible to achieve better performance and reliability and to a lower cost.

Typically, an electrical actuator consists of an electric motor, either a DC motor or an AC servomotor, which is connected through a gearbox to an outgoing shaft in connection with the fuel control shaft. The position of the shaft is measured either from the primary side of the gearbox, the motor axis, or from the secondary side, the outgoing axis. This position is used by the drive electronics which determines the position and, by controlling the current to the motor through a motor driver, runs the outgoing shaft to a requested position. The requested position is sent to the drive electronics from the electronic speed controller.

Although the electrical actuators in many respects are better than their mechanical counterparts, they suffer from a potential safety problem. A mechanical actuator will at all times retain their source of power, as the power is taken from the rotating diesel engine, and will in case of e.g. a total blackout still return the fuel control shaft to a safe position. An electrical actuator, on the other hand, will upon a failure of the electrical supply, either to the drive electronics or the motor driver, render the fuel injection control inactive, thereby leading to an uncontrolled fuel injection and a potentially disastrous over speed event.

To counteract this type of event, the engines with electrically actuated fuel injection control have commonly been equipped with either redundant power supplies, spring actuated safety arrangements or fail safe stopping devices. All of these solutions have their own drawbacks that have prevented them from wider use, and in the end have prevented the electrical actuator to reach the widespread use it could have.

An aim of the invention is to provide an improved actuator assembly for controlling fuel injection of a large combustion engine, especially a diesel engine, which solves the above mentioned and other problems of the prior art and provides a simple, reliable and cost effective arrangement.

The aims of the invention can be met substantially as is disclosed in claim 1 and in the other claims.

### DISCLOSURE OF THE INVENTION

In accordance with the invention the actuator assembly is provided with backup power in the form of capacitor power arranged to provide power for the actuator control means in case of loss of power or power failure of the electric power supply so as to enable the actuator control means to control the electric motor to drive the control shaft to a predefined safe position. Hereby an advantageous solution can be reached for cost effective and reliable provision of backup power for an electric actuator to cope with any kind of electric power failures so as to avoid uncontrolled fuel injection situations.

The actuator control means include a drive electronic unit and a motor driver for controlling the current supplied to the electric motor, whereby preferably these both units are provided with an electric power supply of their own. Thus the capacitor back up power may be utilised according to actual need and independent on which parts of the power supplies are affected by the power failure.

The backup power capacitors are with advantage integrated with the actuator control means so as to directly enable the drive electronic unit to provide an emergency shutdown action. This enables prompt action even when external systems like the speed controller of the engine have failed or lost their power supply.

The electric power supplies are additionally provided with power supply detectors connected to the drive electronic unit for providing information of possible power failure in either one of the electric power supplies. This enables the drive electronics to take independent and rapid action and guarantees for its part that also a reasonable backup power storage will remain sufficient for driving the actuator assembly to a safe position.

The assembly further includes a position indicator arranged to supply the drive electronic unit with position information of the control shaft.

In practice the backup power capacitors comprise with advantage one or several so called super-capacitors. These represent a relatively new technology, where the capacitance, and thereby the energy storage, has been increased tremendously compared to e.g. the commonly known electrolytic capacitors used for decades. Super-capacitors have, compared to other types of energy storage, as lead-acid batteries, NiMH cells etc., the advantage of being extremely long lived even in rather extreme temperatures.

The backup power capacitors are advantageously provided with control electronics for safe charging thereof and provision of stable voltage out from the backup power capacitors. The capacitor control electronics is with advantage connected to the electric power supply for charging of the backup power capacitors. Hereby the charging of the backup power capacitors can simply occur during normal operation of the whole system.

A space saving and compact arrangement can be reached when the drive electronic unit, the motor driver and at least the capacitor control electronics of the backup power capacitors are integrated in one actuator electronics unit.

### BRIEF DESCRIPTION OF DRAWINGS

In the following the invention is described, by way of example only, with reference to the accompanying drawing, the only FIGURE of which provides a schematic diagram of one embodiment of an actuator assembly according to the invention.

### DETAILED DESCRIPTION OF DRAWINGS

In the drawing the reference numeral 1 indicates an actuator electronics unit including a drive electronic unit 2 and a motor driver 3, which are provided with separate electric power supplies 4 and 5 respectively. The actuator electronics unit 1 acts on an electric motor 6 which is connected through a gearbox 7 to an outgoing fuel control shaft 8. The shaft 8 is in a way known as such arranged to control a fuel rack or racks in order to control delivery of fuel by means of fuel pumps into the cylinders of an internal combustion engine, especially a large diesel engine (not shown).

The electric power supplies 4 and 5 are provided with power supply detectors 10 and 11 respectively connected to the drive electronic unit 2 for provision of information about the condition of the power supply. The assembly further comprises a position indicator 9 for providing the drive electronic unit 2 with the correct position of the fuel control shaft 8 in each case. As indicated above the position indicator may be located on the primary side of the gearbox 7, i.e. for measurement from the shaft of the electric motor 6 itself as shown in the drawing, or alternatively the measurement can be made from the secondary side, i.e. from the outgoing shaft 8.

In addition the electrical actuator assembly is provided with backup power capacitors 12 for providing backup power in case of electric power failure of any one of the power supplies 4 or 5. The backup power capacitors 12 are preferably integrated with drive electronic unit 2 in such a way that when a failure of the electronic power of either the power supply 4 or the power supply 5 is detected by the detectors 10 or 11 and the information is sent to the drive electronics unit 2, the drive electronics unit 2 goes into a emergency shutdown mode, and runs the actuator assembly inclusive of the fuel control shaft 8 to a preset safe position. This is generally a position in which no delivery of fuel occurs. Depending on the situation, however, some other preset values may be applied as well, the main aim being that the situation will remain under control.

By integrating the emergency shutdown action in the drive electronic unit 2 it can be guaranteed that the actuator assembly is driven to a safety position with the limited amount of energy stored in the power supply. A non-integrated approach whereby control could be exerted for example through the speed controller of the engine may end up in a too slow response-time, thereby rendering the system without backup power before reaching the safe position. Notwithstanding, in normal operation of the fuel injection system the speed controller supplies position requests to the drive electronic unit 2 as indicated by reference 13.

The backup power capacitors 12 are charged during normal operation from one of the power supplies 4 or 5 and are provided with internal charge/discharge voltage/current control electronics to ensure a safe charging of the capacitors and to secure a stable voltage out from the system. The actuator electronics, i.e. the drive electronic unit 2, the motor driver 3 and the capacitor control electronics are preferably all integrated in the actuator electronics unit 1. The actual backup power capacitors 12, however, may also be situated elsewhere in order to prolong their lifetime in extreme temperature conditions.

The energy storage capacity of the backup power capacitors 12 should be selected such that it may provide the actuator assembly inclusive of the electronics and the electric motor with sufficient energy to rotate the fuel control shaft, and ultimately the fuel rack, to a safe position in view of the fuel delivery upon a loss of external power.

The invention is not limited to the embodiment described but can be implemented in many other different ways within the scope of the inventive idea and the attached claims.

1. An actuator assembly for controlling fuel injection of a large combustion engine, especially a diesel engine, including an electric motor (6) acting on a control shaft (8) arranged to control the fuel injection and actuator control means (2,3) provided with an electric power supply (4,5) for controlling the electric motor (6), characterised in that the actuator assembly is provided with backup power in the form of capacitor power (12) arranged to provide power for the actuator control means (2,3) in case of loss of power or power failure of the electric power supply (4,5) so as to enable the actuator control means (2,3) to control the electric motor (6) to drive the control shaft (8) to a predefined safe position.

2. An actuator assembly according to claim 1, characterised in that the actuator control means (2,3) include a drive electronic unit (2) and a motor driver (3) for controlling the current supplied to the electric motor (6), preferably each provided with an electric power supply (4,5) of their own.

3. An actuator assembly according to claim 2, characterised in that the backup power capacitors (12) are integrated with the actuator control means (2,3) so as to directly enable the drive electronic unit (2) to provide an emergency shutdown action.

4. An actuator assembly according to claim 2, characterised in that the electric power supplies (4,5) are provided with power supply detectors (11,12) connected to the drive electronic unit (2) for providing information of possible power failure in either one of the electric power supplies (4,5).

5. An actuator assembly according to claim 2, characterised in that it includes a position indicator (9) arranged to supply the drive electronic unit (2) with position information of the control shaft (8).

6. An actuator assembly according to claim 1, characterised in that the backup power capacitors (12) comprise one or several so called super-capacitors.

7. An actuator assembly according to claim 1, characterised in that the backup power capacitors (12) are provided with control electronics for safe charging thereof and provision of stable voltage out from the backup power capacitors (12).

8. An actuator assembly according to claim 7, characterised in that said capacitor control electronics is connected to the electric power supply (4,5) for charging of the backup power capacitors (12).

9. An actuator assembly according to claim 2, characterised in that the drive electronic unit (2), the motor driver (3) and at least the capacitor control electronics of the backup power capacitors (12) are integrated in one actuator electronics unit (1).
